(19) United States
(12) Patent Application Publication
(10) Pub. No.: US 2014/0379212 A1
(43) Pub. Date: Dec. 25, 2014

(54) BLIND CONTROL SYSTEM FOR VEHICLE

(71) Applicant: Hyundai Motor Company, Seoul (KR)

(72) Inventors: Jungsang MIN, Seoul (KR); Gi Beom HONG, Bucheon-si (KR)

(73) Assignee: HYUNDAI MOTOR COMPANY, Seoul (KR)

(21) Appl. No.: 14/145,033

(22) Filed: Dec. 31, 2013

(30) Foreign Application Priority Data
Jun. 21, 2013 (KR) 10-2013-0071856

(51) Int. Cl. G06F 3/0484; G06F 3/0488; G06F 3/0482

(52) U.S. Cl. CPC G06F 3/04842; G06F 3/0482; G06F 3/0488
USPC 701/36; 715/834

(57) ABSTRACT

A blind control system for the vehicle includes an input detector that detects a user's touch and a drag motion, a controller that uses a touch position on the input detector as a reference point and activates or deactivates a pie menu of a drag motion with respect to the reference point, among a plurality of predetermined pie menus. A display displays the pie menu activated by the control portion.

### CROSS-REFERENCE TO RELATED APPLICATION

This application claims the benefit of priority to Korean Patent Application No. 10-2013-0071856 filed in the Korean Intellectual Property Office on Jun. 21, 2013, the entire contents of which are incorporated herein by reference.

### TECHNICAL FIELD

The present disclosure relates to a blind control system for a vehicle, and more particularly, to a blind control system for a vehicle which can minimize a driver's distraction while driving.

### BACKGROUND

A variety of electronic devices, such as a navigation system, a multimedia system, or an air conditioning system, is provided in recent vehicles for the convenience of drivers.

Electronic devices in existing vehicles provide a user interface through a designated button, and touchscreen has become one of common technologies nowadays. Such devices require drivers to touch and manipulate with their hands, which may cause a disturbance in safe driving because it distracts the drivers' sight and hand movements from driving.

Safe driving can be achieved if the driver can have a wide field of view and a convenient posture while manipulating the devices. That is, there is the need to develop an interface technology which offers convenience for users without giving any disturbance with driving.

The above information disclosed in this Background section is only for enhancement of understanding of the background of the disclosure, and therefore, it may contain information that does not form the prior art that is already known in this country to a person of ordinary skill in the art.

### SUMMARY

The present disclosure provides a blind control system for a vehicle which can minimize a driver's attention to the center fascia equipped with input buttons for controlling electronic devices provided in the vehicle while driving.

According to an exemplary embodiment of the present disclosure, a blind control system for a vehicle includes an input detector that detects a user's touch and a drag motion. A controller uses a touch position on the input detector as a reference point and activates or deactivates a pie menu of the drag motion with respect to the reference point, among a plurality of predetermined pie menus. A display displays the pie menu activated by the controller.

The input detector may be a touchscreen.

The display may be a head-up display (HUD).

The display may display the activated pie menu at a given position.

The position of the pie menu may vary.

The pie menu may include at least one of a navigation system, a multimedia system, and an air conditioning system.

The blind control system for the vehicle may further include a sub menu input that runs the sub menus of the pie menu when the pie menu is executed.

The sub menu input may be a gesture recognizer that recognizes a user's gesture.

The gesture recognizer may include an image capturer for capturing an image of a driver, and an image storage for storing an image captured by the image capturer. An information database stores body trajectory information, wherein the controller may execute a series of commands for comparing an input signal from the image capturer with cumulative image information stored in the image storage and controlling vehicle equipment operations.

The input detector may be a touchscreen.

The display may be a head-up display (HUD).

The display may display the activated pie menu at a given position.

The position of the pie menu may vary.

The sub menu input may be the touchscreen.

If the plurality of predetermined pie menus includes a navigation system and the activated pie menu is for the navigation system, the input of the sub menus may be at least one of a simple touch on the touchscreen, dragging left/right, dragging up/down, and drawing a circle.

If the plurality of predetermined pie menus includes a communication system and the activated pie menu is for the communication system, the input of the sub menus may be at least one of a simple touch on the touchscreen, dragging left/right, dragging up/down, and drawing a circle.

If the plurality of predetermined pie menus includes an air conditioning system and the activated pie menu is for the air conditioning system, the input of the sub menus may be at least one of a simple touch on the touch screen, dragging left/right, dragging up/down, drawing a circle, and making a zigzag pattern.

If the plurality of predetermined pie menus includes an audio system and the activated pie menu is for the audio system, the input of the sub menus may be at least one of a simple touch on the touch screen, dragging left/right, dragging up/down, drawing a circle, and making a zigzag pattern.

If the plurality of predetermined pie menus includes a radio system and the activated pie menu is for the radio system, the input of the sub menus may be at least one of a simple touch on the touch screen, dragging left/right, dragging up/down, drawing a circle, and making a zigzag pattern.

According to the blind control system for the vehicle according to an exemplary embodiment of the present disclosure, the driver is prevented from being distracted while driving, thereby increasing the convenience of a user interface (UI) operation while driving and avoiding traffic accidents.

### BRIEF DESCRIPTION OF THE DRAWINGS

FIG. 1 and FIG. 2 are views for explaining an input detector of a blind control system for a vehicle according to an exemplary embodiment of the present disclosure.

FIG. 3 is a view showing a display portion of a blind control system for a vehicle according to an exemplary embodiment of the present disclosure.

FIG. 4 is a block diagram of a blind control system for a vehicle according to an exemplary embodiment of the present disclosure.

FIG. 5 is an illustration of motions corresponding to hand trajectories applicable to a gesture recognizer of a blind control system for a vehicle according to an exemplary embodiment of the present disclosure.

FIG. 6 is a view for explaining a sub menu input method using a touchscreen of a blind control system for a vehicle according to an exemplary embodiment of the present disclosure.

### DETAILED DESCRIPTION OF THE EMBODIMENTS

In the following detailed description, only certain exemplary embodiments of the present disclosure have been shown and described, simply by way of illustration.

As those skilled in the art would realize, the described embodiments may be modified in various different ways, all without departing from the spirit or scope of the present disclosure

Throughout the specification, same parts are denoted by same reference numerals. Unless explicitly described to the contrary, the word “comprise” and variations such as “comprises” or “comprising,” will be understood to imply the inclusion of stated elements but not the exclusion of any other elements.

An exemplary embodiment of the present disclosure will hereinafter be described in detail with reference to the accompanying drawings.

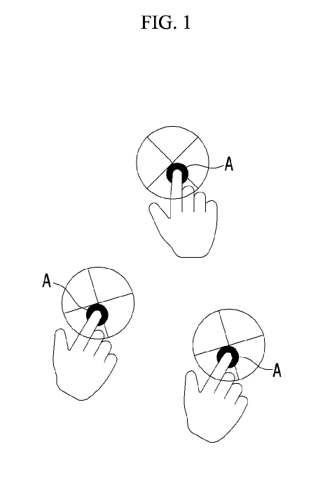

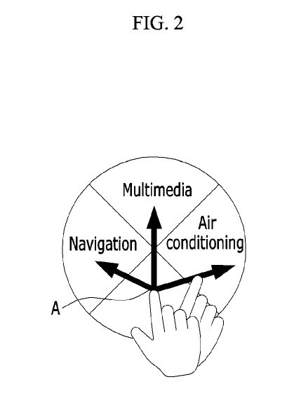

FIG. 1 and FIG. 2 are views for explaining an input detector of a blind control system for a vehicle according to an exemplary embodiment of the present disclosure.

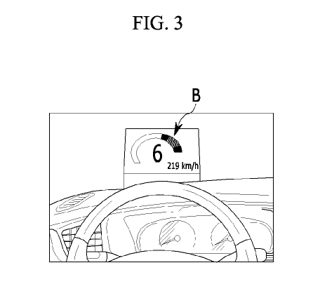

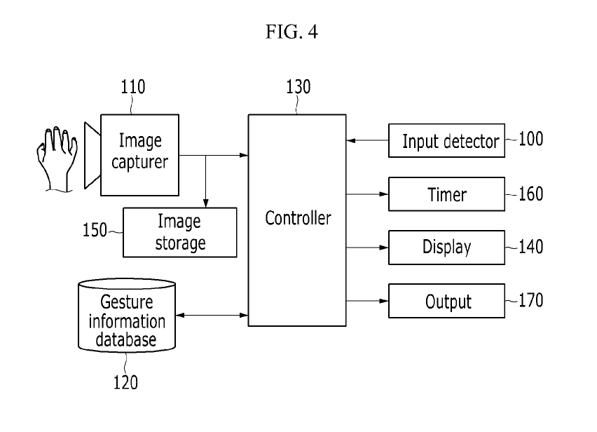

FIG. 3 is a view showing a display portion of a blind control system for a vehicle according to an exemplary embodiment of the present disclosure. FIG. 4 is a block diagram of a blind control system for a vehicle according to an exemplary embodiment of the present disclosure.

Referring to FIGS. 1 to 4, a blind control system for a vehicle according to an exemplary embodiment of the present disclosure includes an input detector 100 that detects a user's touch and a drag motion, a controller 130 that uses a touch position on the input detector as a reference point A and activates or deactivates a pie menu of the drag motion with respect to the reference point A, among a plurality of predetermined pie menus, and a display 140 that displays the pie menu activated by the controller 130.

The input detector 100 may be a touchscreen, and the display 140 may be a head-up display (HUD).

The pie menu may be defined as a top menu, which is a combination of operation menus of a variety of systems such as a navigation system, a multimedia system, or an air conditioning system that a driver operates. The pie menu may include at least one of the above mentioned systems. The multimedia system refers to a system including making a call, playing music, and playing radio.

Referring to FIGS. 1 and 2, the driver touches a specific region of a touch screen on a center fascia with a finger in order to run the menus like multimedia, air conditioning, and navigation. Then, the controller 130 forms a pie menu, which is the top menu, with respect to the finger touch position used as the reference point A. Next, the driver makes a drag motion, and the controller 130 activates or deactivates the pie menu by the drag motion with respect to the reference point A. Since a position at which the touchscreen is touched by the driver serves as the reference point A, the driver can easily activate or deactivate the pie menu without being distracted while driving.

Accordingly, the driver can run or stop the system without focusing his or her attention to the center fascia.

The display 140 can display the pie menu activated or deactivated by the controller 130 and feed it back to the driver, thus making it easy for the driver to see the currently-running pie menu.

The blind control system for the vehicle according to an exemplary embodiment of the present disclosure can activate or deactivate the top menu (pie menu) without being distracted while driving, and provide feedback to the driver to ensure safe driving.

Referring to FIG. 3, the display 140 can display the activated pie menu as an icon or a text at a position B which can vary. Therefore, the driver can efficiently see the currently activated pie menu.

The blind control system for the vehicle may further include a sub menu input that runs the sub menus of the pie menu when the pie menu is executed. The sub menu input may be a gesture recognizer that recognizes a user's gesture.

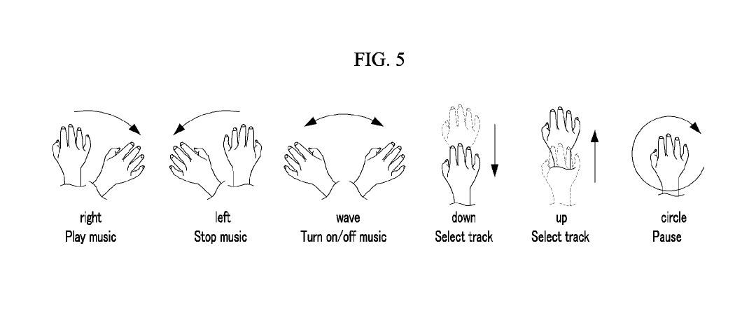

FIG. 5 is an illustration of motions corresponding to hand trajectories applicable to a gesture recognizer of a blind control system for a vehicle according to an exemplary embodiment of the present disclosure.

Referring to FIGS. 4 and 5, the gesture recognizer includes an image capturer 110 for capturing an image such as a driver, an image storage 150 for storing an image captured by the image capturer 110, and an information database 120 for storing body trajectory information. The controller 130 can execute a series of commands for comparing an input signal from the image capturer 110 with cumulative image information stored in the image storage 150 and controlling vehicle equipment operations.

The image capturer 110 includes a camera, an optical sensor, an ultrasonic sensor, and an image sensor. One or a plurality of image capturers 110 can be installed at various positions within the vehicle.

The image storage 150 accumulates and stores frames of an image captured by the image capturer 110.

The gesture recognizer may include a timer 160 to check time.

The information database 120 stores the trajectory information of predefined body parts, for example, hands, legs, etc. The stored body trajectory information may be preset for generally defined trajectories. For example, the preset hand trajectory information may appear as shown in FIG. 5, and other types of hand trajectory information may be provided.

Although the hand movements of FIG. 5, such as moving right, moving left, waving, moving down, moving up, and circling, are defined as play music, stop music, turn on/off music, select track (down/up), and pause, these definitions can be modified in various ways.

Moreover, the information database 120 stores the body trajectory information registered by the driver. The driver can select various types of body trajectory information and store it as the body trajectory information. That is, each driver can enter his or her own hand trajectory so that different body trajectory information by each driver can be recognized without error.

The controller 130 obtains hand image trajectory information, which is defined during a predetermined time by comparing the current frame of an image of a body part, for example, a driver's hand, captured by the image capturer 110, with the cumulative image frames stored in the image storage 110. The predetermined time is the time at which a hand trajectory is formed, which is set in the timer 160.

Moreover, the controller 130 determines if the body trajectory information matching the obtained body trajectory information is stored in the information database 120. If there is matching body trajectory information stored, the controller 130 recognizes the stored body trajectory information as the driver's body trajectory. In addition, if there is no matching body trajectory information stored, the body trajectory information is deemed non-identifiable and not recognized.

Furthermore, the controller 130 selects a vehicle device operation corresponding to the pie menu which is activated by the input detector 100. A list of corresponding vehicle device operations can be created and stored in a database, and a control signal corresponding to the selected vehicle device operation provides the operation that the occupant wants. Examples of the selectable vehicle device operations include pick up or hang up the phone while driving, play/stop/mute music, volume up/down, manipulate the air conditioning system, manipulate the navigation system, and so on.

The gesture recognizer further includes an output 170, and the output 170 includes at least one of a navigator, a multimedia, and an air conditioner.

The controller 130 selects a system that the driver wants to run through the input detector 100, and recognizes the sub menus of the system through the gesture recognizer and runs them.

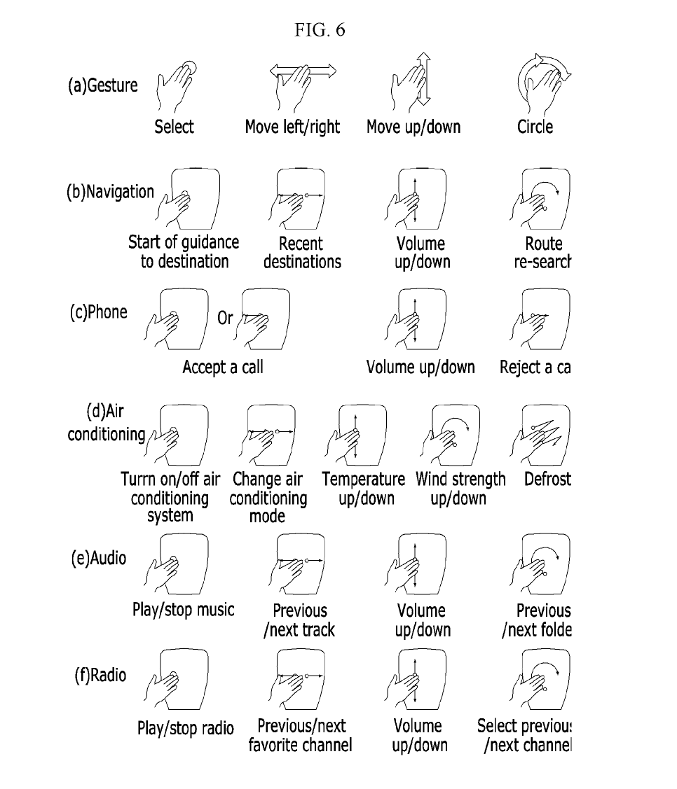

FIG. 6 is a view for explaining a sub menu input method using a touchscreen of a blind control system for a vehicle according to an exemplary embodiment of the present disclosure.

Referring to FIG. 6, when the pie menu is activated through the input detector 100, i.e., a touchscreen, the blind control system for the vehicle according to an exemplary embodiment of the present disclosure activates the sub menus of the pie menu through the touchscreen.

For example, as shown in FIG. 6(a), the input of the sub menus may include a simple touch (once or more than twice), dragging left/right, dragging up/down, drawing a circle, etc.

If the selected pie menu (top menu) is for a navigator, the simple touch can be set as the start of guidance to a destination, dragging left/right can be set as search for recent destinations, dragging up/down can be set as volume up/down, and drawing a circle can be set as route re-search, with reference to FIG. 6(b).

If the selected pie menu (top menu) is for a phone (communication) system, the simple touch or dragging left can be set as accept a call, dragging up/down can be set as volume up/down, and dragging right can be set as reject a call, with reference to FIG. 6(c).

If the selected pie menu (top menu) is for an air conditioning system, the simple touch can be set as turn on/off the air conditioning system, dragging left/right can be set as change the air conditioning mode, dragging up/down can be set as temperature up/down, and drawing a circle can be set as wind strength up/down, and making a zigzag pattern can be set as defrost, with reference to FIG. 6(d).

If the selected pie menu (top menu) is for an audio system, the simple touch can be set as play or stop music, dragging left/right can be set as select the previous or next track, dragging up/down can be set as volume up/down, and drawing a circle can be set as select a next folder, with reference to FIG. 6.

If the selected pie menu (top menu) is for a radio system, the simple touch can be set as play or stop radio, dragging left/right can be set as select the previous/next favorite channel, dragging up/down can be set as volume up/down, and drawing a circle can be set as select the next channel.

While the execution of the sub menus using the touchscreen has been described with reference to FIG. 6, the present disclosure is not limited to the above-explained example, and various forms or patterns of input gestures can be set for various kinds of systems to ensure the driver's convenience and safety.

As explained above, the blind control system for the vehicle according to the exemplary embodiment of the present disclosure can minimize the driver's need to divert his or her attention to operate electronic devices within the vehicle while driving, thereby ensuring safe driving of the vehicle.

While this disclosure has been described in connection with what is presently considered to be practical exemplary embodiments, it is to be understood that the disclosure is not limited to the disclosed embodiments. On the contrary, it is intended to cover various modifications and equivalent arrangements included within the spirit and scope of the appended claims.

What is claimed is:

1. A blind control system for a vehicle, the system comprising:
an input detector that detects a user's touch and a drag motion;
a controller that uses a touch position on the input detector as a reference point and activates or deactivates a pie menu of the drag motion with respect to the reference point among a plurality of predetermined pie menus; and
a display that displays the pie menu activated by the controller.

2. The blind control system of claim 1, wherein the input detector is a touchscreen.

3. The blind control system of claim 2, wherein the display is a head-up display (HUD).

4. The blind control system of claim 3, wherein the display displays the activated pie menu at a given position.

5. The blind control system of claim 4, wherein the given position of the pie menu varies.

6. The blind control system of claim 1, wherein the pie menu comprises at least one of a navigation system, a multimedia system, and an air conditioning system.

7. The blind control system of claim 1, further comprising a sub menu input that runs sub menus of the pie menu when the pie menu is executed.

8. The blind control system of claim 7, wherein the sub menu input is a gesture recognizer that recognizes a user's gesture.

9. The blind control system of claim 8, wherein the gesture recognizer comprises:
an image capturer for capturing an image of a driver;
an image storage for storing the image captured by the image capturer; and
an information database for storing body trajectory information,
wherein the controller executes a series of commands for comparing an input signal from the image capturer with cumulative image information stored in the image storage and controlling vehicle device operations.

10. The blind control system of claim 9, wherein the input detector is a touchscreen.

11. The blind control system of claim 10, wherein the display is a head-up display (HUD).

12. The blind control system of claim 11, wherein the display displays the activated pie menu at a given position.

13. The blind control system of claim 12, wherein the given position of the pie menu varies.

14. The blind control system of claim 7, wherein the sub menu input is a touchscreen.

15. The blind control system of claim 14, wherein, if the plurality of predetermined pie menus comprises a navigation system and the activated pie menu is for the navigation system, an input of the sub menus is at least one of a simple touch on the touchscreen, dragging left/right, dragging up/down, and drawing a circle.

16. The blind control system of claim 14, wherein, if the plurality of predetermined pie menus comprises a communication system and the activated pie menu is for the communication system, an input of the sub menus is at least one of a simple touch on the touchscreen, dragging left/right, dragging up/down, and drawing a circle.

17. The blind control system of claim 14, wherein, if the plurality of predetermined pie menus comprises an air conditioning system and the activated pie menu is for the air conditioning system, an input of the sub menus is at least one of a simple touch on the touchscreen, dragging left/right, dragging up/down, drawing a circle, and making a zigzag pattern.

18. The blind control system of claim 14, wherein, if the plurality of predetermined pie menus comprises an audio system and the activated pie menu is for the audio, an input of the sub menus may be at least one of a simple touch on the touch screen, dragging left/right, dragging up/down, drawing a circle, and making a zigzag pattern.

19. The blind control system of claim 14, wherein, if the plurality of predetermined pie menus comprises a radio and the activated pie menu is for the radio system, an input of the sub menus is at least one of a simple touch on the touch screen, dragging left/right, dragging up/down, drawing a circle, and making a zigzag pattern.
